(19) United States
(12) Patent Application Publication
(10) Pub. No.: US 2009/0096673 A1
(43) Pub. Date: Apr. 16, 2009

(54) Printed wiring board and antenna unit

(75) Inventors: Nobuo Nakajima, Tokyo (JP); Koichi Gyoda, Tokyo (JP); Eiji Shibuya, Kobe-shi (JP); Takehiro Onomatsu, Osaka (JP); Hideto Yoshimura, Osaka (JP)

Correspondence Address: Yokoi & Company U.S.A., INC., 13700 Marina Pointe Drive, Suite #723, Marina Del Rey, CA, 90292, US

(73) Assignees: THE UNIVERSITY OF ELECTRO-COMMUNICATIONS, Tokyo (JP); DX Antenna Company, Limited, Hyogo-ken (JP); Funai Electric Co., Ltd., Osaka (JP)

(21) Appl. No.: 12/287,431

(22) Filed: Oct. 9, 2008

(30) Foreign Application Priority Data
Oct. 10, 2007 (JP) JP2007-264358

(51) Int. Cl. H01Q 3/00

(52) U.S. Cl. 342/374

(57) ABSTRACT

A printed wiring board is provided with a multidirectional antenna having plural directivities, and an antenna control circuit for selectively setting the multidirectional antenna for one of the directivities. The antenna control circuit is formed in a predetermined area on the printed wiring board, the antenna includes plural flat antenna elements of a predetermined length, and the antenna elements are formed on one of the opposite surfaces of the printed wiring board so as to extend radially outward from the predetermined area and connected to the antenna control circuit.

### CROSS REFERENCE TO RELATED APPLICATIONS

The present application is related to the Japan Utility Model Application No. 2007-264358, filed Oct. 10, 2007, the entire disclosure of which is expressly incorporated by reference herein.

### BACKGROUND OF THE INVENTION

1. Field of the Invention

The present invention relates to a printed wiring board provided with an antenna control circuit, and an antenna unit provided with the printed wiring board.

2. Description of the Related Art

There is a known antenna unit for receiving broadcast television signals, capable of automatically changing its directivity generally called a smart antenna. Such an antenna unit has a substrate provided with antenna elements forming an antenna, and a substrate provided with a control circuit for changing the directivity of the antenna.

A sector antenna unit mentioned in JP-A 2000-36710 (Document 1) is built by arranging sector units formed by surrounding antenna elements on the inner side by sectorial reflectors opening outward in an annular arrangement on a disk-shaped metal base plate, and disposing circuit elements of a radio device in a central part of the metal base plate surrounded by the inner ends of the sectorial reflectors.

A module with an antenna mentioned in JP-A 2004-201145 (Document 2) is formed by attaching a conducting patch serving as an antenna to the surface of a base member, and forming an RF circuit on the surface of the conducting patch.

A composite communication module mentioned in JP-A2002-152069 (Document 3) is built by fixing an antenna unit formed by forming a radiation electrode on a surface of a dielectric base member having a vacant central part to a wiring board, and placing an infrared ray transmitter-receiver in the vacant central part of the dielectric base member.

The antenna unit called a smart antenna, for example, is connected to a television receiver and is disposed at a position above the back of the television receiver.

As mentioned above, this antenna unit has the substrate provided with the antenna elements, and the substrate provided with the control circuit, and the substrates are disposed in two layers. Therefore, this antenna unit lacks compactness and is unsatisfactory in appearance because the antenna unit is big.

The reflectors of the sector units of the sector antenna unit mentioned in Document 1 need to be set up on the metal base plate. Therefore, a large three-dimensional antenna structure is mounted on the metal base plate. Thus, the sector antenna unit, similarly to the conventional antennas, is difficult to be formed in a small size.

Documents 2 and 3 are not inventions related with a smart antenna. The composite communication module mentioned in Document 3 has the antenna unit including the radiation electrode and the dielectric base member and set up on the wiring board. Since the large, three-dimensional structure serving as an antenna is formed on the wiring board, the antenna unit lacks compactness.

### BRIEF SUMMARY OF THE INVENTION

The present invention provides a printed wiring board, effective in forming an antenna unit in a small size and in improving the appearance of an antenna unit, and capable of eliminating a bad influence of dimensional reduction on signal receiving performance, and an antenna unit provided with the printed wiring board.

A printed wiring board according to the present invention is provided with an antenna control circuit for switching directivities of an antenna having plural directivities, the antenna control circuit is formed in a predetermined area on the printed wiring board, and plural flat antenna elements of a predetermined length forming the antenna and connected to the antenna control circuit are arranged so as to extend radially outward around the predetermined area on one of both surfaces of the printed wiring board.

According to the present invention, the antenna having plural directivities and including the antenna control circuit and the plural antenna elements is formed on a single printed wiring board in a small size. Thus, the size of the antenna unit with the printed wiring board is substantially equal to that of the printed wiring board and is smaller than those of conventional antenna units. The small antenna unit has a satisfactory appearance.

The plural antenna elements are arranged on the surface of the printed wiring board opposite the surface on which the antenna control circuit is formed. A ground (earth) pattern covering the predetermined area excluding through holes for mounting the antenna control circuit may be formed on the surface of the printed wiring board on which the antenna control circuit is formed. When the predetermined area excluding the through holes for mounting the antenna control circuit is covered with a ground, it is possible to prevent high-frequency signals, namely, broadcast television signals, received by the antenna (antenna elements) being made unstable by noise generated by the antenna control circuit.

The ground pattern may be a metal plate separate from the printed wiring board, and having one surface coated with an insulating member. The metal plate may be attached to the printed wiring board with the insulating member facing the printed wiring board. A pattern as the ground is not formed in the predetermined area, and wiring patterns necessary for the operation of the antenna unit can be formed in the predetermined area. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a perspective view of an antenna unit in a preferred embodiment according to the present invention attached to a television receiver;

FIG. 2 is an exemplary illustration of a block diagram of the antenna unit;

FIG. 3 is an exemplary illustration of a diagrammatic view of assistance in explaining the positional relation of antenna elements and directions of directivities;

FIG. 4 is an exemplary illustration of a top view of a printed wiring board;

FIG. 5 is an exemplary illustration of a bottom view of the printed wiring board shown in FIG. 4;

FIG. 6 is an exemplary illustration of a fragmentary bottom view of the printed wiring board; and

FIG. 7 is an exemplary illustration of a fragmentary perspective view of a meal plate.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized. For purposes of illustration, programs and other executable program components are illustrated herein as discrete blocks, although it is recognized that such programs and components may reside at various times in different storage components, and are executed by the data processor(s) of the computers. Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. An antenna unit in a preferred embodiment according to the present invention will be described.

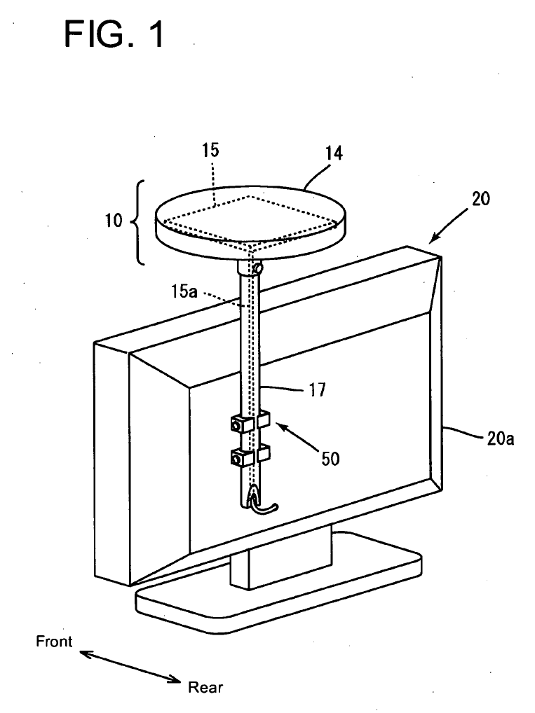

Referring to FIG. 1 showing an antenna unit 10 in a preferred embodiment according to the present invention in a perspective view, the antenna unit 10 for receiving, for example, broadcast television signals has a disk-shaped housing 14 of a predetermined thickness, and a printed wiring board 15 fixedly disposed in the housing 14. The shape of the housing 14 is not limited to that of a disk. The printed wiring board 15 is a wiring board with an antenna control circuit of the present invention. The antenna unit 10 has the function of the smart antenna.

As shown in FIG. 1, a pole 17 attached to a central part of the bottom wall of the housing 14 is attached to, for example, a television receiver 20 to hold the antenna unit 10 above the back of the television receiver 20. The antenna unit 10 is held with the bottom surface of the housing 14 on which the printed wiring board 15 is placed held in a horizontal position. In FIG. 1, predetermined parts of the pole 17 is fixedly held on the back surface of the cabinet 20a of the television receiver 20 by fixing devices 50 formed on the back surface of the cabinet 20. The pole 17 is a hollow, tubular member. A cable 15a electrically connecting the printed wiring board 15 and the television receiver 20 is extended through the pole 17.

The user can install the antenna unit 10 indoors or outdoors at an optional place. A device to which the antenna unit 10 is connected by the cable 15a is not limited to the television receiver 20 and may be a personal computer or the like provided with a tuner.

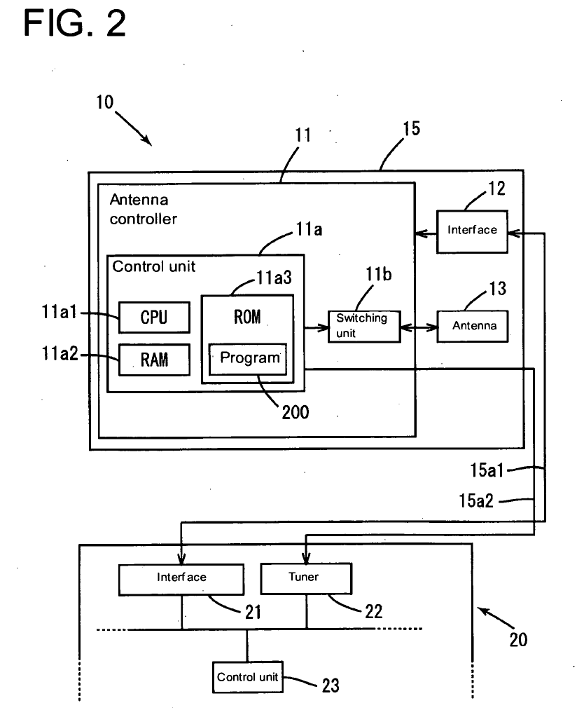

FIG. 2 is a block diagram of the antenna unit 10 and part of the television receiver 20.

The antenna unit 10 can electrically change its directivity to receive broadcast television signals. The printed wiring board 15 of the antenna unit 10 is provided with an antenna controller 11, an interface 12, and an antenna 13 having plural directivities one of which can be selectively used for receiving broadcast television signals. The antenna controller 11 corresponds to an antenna control circuit according to the present invention.

The interface 12 is connected to, for example, an interface 21 included in the television receiver 20 by a cable 15a1 included in the cable 15a.

The interface 21 of the television receiver 20 communicates with the interface 12 of the antenna unit 10 by procedures specified in a communication protocol, such as EIA/CEA-900, according to control signals given thereto by a controller 23, such as a microcomputer, included in the television receiver 20 to send channel information and such for controlling the antenna unit 10 to the antenna unit 10.

The channel information includes information about the number of a physical channel, and information about a direction in which the directivity of the antenna 13 is to be set. The controller 23 of the television receiver 20 refers to a channel map or the like stored beforehand in a predetermined storage medium and reads channel information including information about the number of a physical channel specified by the user by operating a remote controller, not shown, and information about a direction from the channel map or the like. Then, the controller 23 sends the information read from the channel map through the interface 21 to the antenna unit 10.

The antenna controller 11 has a control unit 11a and a switching unit 11b. The control unit 11a includes, for example, a CPU 11a1, a RAM 11a2 and a ROM 11a3. In the control unit 11a, the CPU 11a1 uses the RAM 11a2 as a work area and executes procedures according to a predetermined program 200 stored in the ROM 11a3. More concretely, the control unit 11a receives the channel information through the interface 12 and causes the switching unit 11b to switch directivities of the antenna 13 based on the information about the direction included in the channel information.

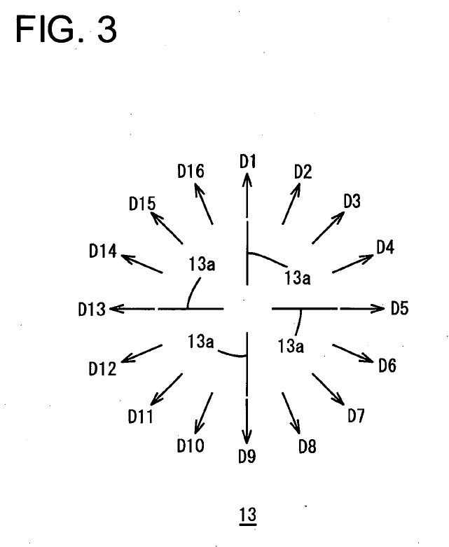

FIG. 3 is a diagrammatic view of assistance in explaining the positional relation of antenna elements 13a and directions of directivities of the antenna 13. The antenna 13 has plural antenna elements radially extended on a plane parallel to the surface of the printed wiring board 15. In this embodiment, the antenna 13 has four antenna elements 13a as shown in FIG. 3. In FIG. 3, the four antenna elements 13a are extended at equal angular intervals of 90°. The antenna elements 13a can individually receive broadcast television signals. The antenna elements 13a have high sensitivities with respect to radially outward directions parallel to their lengths, respectively. Thus, the antenna 13 provided with the antenna elements 13a respectively having high sensitivities with respect to different radially outward directions and arranged at equal angular intervals has satisfactory sensitivities with respect to the radially outward directions.

If the antenna 13 can always receive broadcast television signals from all directions, noise radio waves coming from directions other than a direction from which broadcast television signals on the channel specified by the user are received. Therefore, the switching unit 11b executes a procedure for limiting the directivity of the antenna 13 to a single direction. The switching unit 11b can make the antenna 13 have directivities in plural directions in addition to the directions parallel to the lengths of the antenna elements 13a by changing (adjusting) the phases of signals received by the antenna elements 13a and providing a composite signal obtained by synthesizing those signals received by the antenna elements 13a.

More concretely, plural combinations, such as sixteen combinations, of phase adjustments for signals provided by the antenna elements 13a are stored in a predetermined storage area of the ROM 11a3. The control unit 11a reads a combination of phase adjustments corresponding to the information about direction from the ROM 11a3 and gives the combination of phase adjustments to the switching unit 11b. The switching unit 11b adjusts the respective phases of the signals received from the antenna elements 13a by using the phase adjustments specified by the combination for those signals. The switching unit 11b can select one of the directivities, for example, sixteen directivities, of the antenna 13 on the basis of the instruction given thereto by the control unit 11a. FIG. 3 shows the respective directions of the sixteen directivities. In this embodiment, the switching unit 11b can select one of the sixteen directivities in sixteen directions D1 to D16 radially extending at equal angular intervals from the center of an area surrounded by the antenna elements 13a as shown in FIG. 3.

The antenna controller 11 is electrically connected to tuner 22 of the television receiver 20 by the cable 15a2 included in the cable 15a. The antenna controller 11 sends the broadcast television signals received by the antenna 13 using the directivity with respect to the direction specified by the information about direction to the television receiver 20.

The tuner 22 of the television receiver 20 extracts signals of a frequency in a frequency band of the channel selected by the user from the broadcast television signals received from the antenna unit 10 in conformity to a control signal received from the control unit 23. The television receiver 20 can carry out operations of general television receivers. The television receiver 20 can demodulate video and audio signals from the signals of the specified frequency, can execute a series of processes including a process for making the display panel display images based on the video signals and a process for making the loudspeaker generate sounds based on the acoustic signals. The series of processes and component parts necessary for carrying out those processes are similar to those of the known television receivers.

Configuration of the components of the printed wiring board 15 will be described.

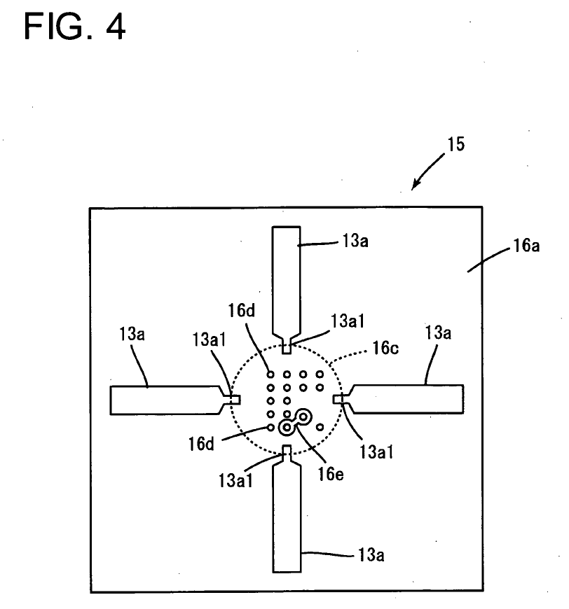

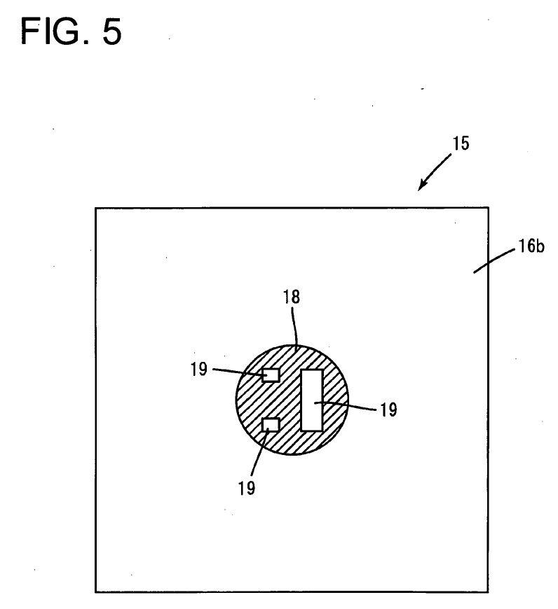

FIG. 4 is a schematic plan view of one of opposite surfaces of the printed wiring board 15, and FIG. 5 is a schematic plan view of the other surface of the printed wiring board 15.

More concretely, FIG. 4 is the upper surface 16a of the printed wiring board 15 facing down when the printed wiring board 15 is placed in the housing 14, and FIG. 5 is the lower surface 16b of the printed wiring board facing down when the printed wiring board 15 is placed in the housing 14.

As shown in FIG. 4, the four antenna elements 13a are extended radially outward from a central area 16c on the upper surface 16a. As mentioned above in connection with FIG. 3, the four antenna elements 13a are extended radially from a central area 16c of the upper surface 16a at equal angular intervals on the printed wiring board 15. The antenna elements 13a are flat antenna elements formed by, for example, etching a metal film attached to the printed wiring board 15. The antenna elements 13a are provided at their radially inner ends with terminals 13a1, respectively. The number and shape of the antenna elements 13a are not limited to those specifically described herein and may be any suitable number and any suitable shape.

Through holes 16d are formed in the central area 16c at plural positions, respectively, so as to extend between the upper surface 16a and the lower surface 16b.

As shown in FIG. 5, electronic parts 19, such as integrated circuits, forming the antenna controller 11 and the interface 12 are mounted on an area corresponding to the central area 16c of the upper surface 16a in the lower surface 16b. Although the electronic parts 19 can be arranged in the central area 16c of the upper surface 16a, the electronic parts 19 are arranged on the lower surface 16b in view of the signal receiving stability of the antenna elements 13a in this embodiment. Although not illustrated in FIGS. 4 and 5, the pins of the electronic parts 19 are inserted in the through holes 16d and are connected to circuits formed on the printed wiring board 15.

The electronic parts 19 shown in FIG. 5 may be the antenna controller 11 and the interface 12. Thus, the single printed wiring board 15 is provided with the antenna controller 11 and the antenna elements 13a extended radially from the central area 16c, namely, the predetermined area, in which the antenna controller 11 is placed.

The antenna elements 13a formed on the upper surface 16a are electrically connected through the terminals 13a1, a wiring pattern formed in the central area 16c and the through holes 16d to the electronic parts 19 forming the antenna controller 11. A wiring pattern 16e necessary for connecting the electronic parts 19 to form the antenna controller 11 and the interface 12 is formed in the central area 16c. Only a very small part of the wiring pattern 16e is formed in FIG. 4. The cable 15 is connected through terminals and a wiring pattern, not shown, formed on the printed wiring board 15 specially for the cable 15 to the electronic parts 19.

When the antenna elements 13a for receiving broadcast television signals, and the antenna control circuit are formed close to each other on the upper and the lower surface, respectively, of the single printed wiring board 15 as mentioned above, it is expected that unnecessary noise radiated from, for example, the antenna control circuit affects high-frequency signals received by the antenna elements.

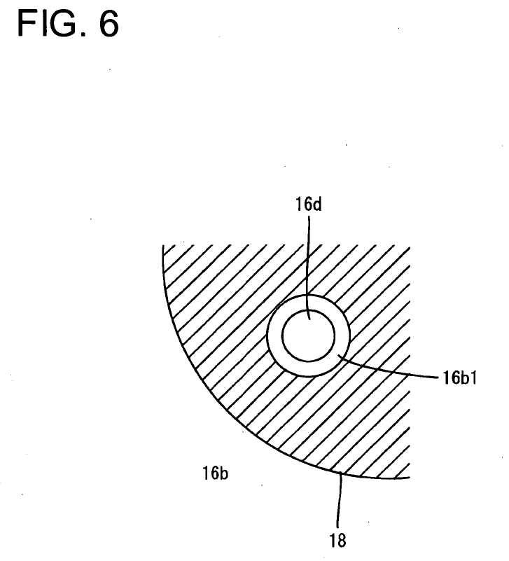

In the printed wiring board 15 shown in FIG. 5, a ground pattern (ground area) 18 is formed in an area on the lower surface 16b corresponding to the central area 16c in the upper surface 16a. The ground pattern 18 excluding parts thereof corresponding to the electronic parts 19 is a shaded area in FIG. 5. The ground pattern 18 covers at least parts of the lower surface 16b on which the electronic parts 19 forming the antenna controller 11, namely, the antenna control circuit, and the interface 12 are placed. The ground pattern 18 may be connected to a ground pattern formed on the upper surface 16a. The ground pattern 18 is not formed on annular areas of a predetermined width on the lower surface 16b respectively surrounding the through holes 16d for mounting the electronic parts 19 on the printed wiring board 15. FIG. 6 shows one of the through holes 16d and a part of the ground pattern 18 around the through hole 16d on the lower surface 16b.

In the embodiment described herein, the antenna control circuit and the antenna elements 13a are formed on the single printed wiring board 15, and the antenna elements 13a are radially extended from the area in which the antenna control circuit is formed. Thus, the single printed wiring board is disposed in the housing 14 of the antenna unit 10. Thus, the antenna unit 10 has a very small internal configuration as compared with that of a conventional antenna unit provided with both a substrate provided with antenna elements and a substrate provided with a control circuit for selecting a directivity, and that of a conventional antenna unit provided with a substrate mounted with a predetermined three dimensional structure for realizing an antenna function. The antenna unit 10 including the housing 14 can be formed in a small size, the antenna unit 10 does not require a large space for installation, and the antenna unit 10 has a satisfactory appearance.

The antenna elements 13a and the antenna control circuit are formed on the opposite surfaces, respectively, of the printed wiring board 15, and the area on which the antenna control circuit is formed is covered with the ground pattern 18 as shown in FIGS. 4 and 5. Therefore, the influence of unnecessary noise radiated from the antenna control circuit on signals received by the antenna elements 13a can be effectively prevented and hence the antenna unit 10 can maintain stable signal receiving performance.

A ground area may be formed around the antenna control circuit by the following method.

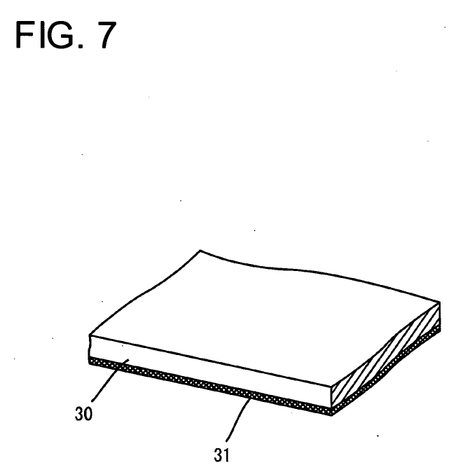

FIG. 7 is a perspective view of a metal sheet 30, such as a copper sheet. One of the opposite surfaces of the metal sheet 30 is coated with an insulating film 31. A ground area may be formed by applying the metal sheet 30 to the printed wiring board 15 with the insulating film 31 facing the printed wiring board 15 so as to cover a predetermined area. For example, when a wiring pattern 16e is formed on the lower surface 16b as well as on the upper surface 16a, the metal sheet 30 is applied to a part of the lower surface 16b in which the wiring pattern 16e is formed with the insulating film 31 facing the lower surface 16b.

More concretely, the metal sheet 30 having a shape similar to that of the ground pattern 18 is applied to the area in the lower surface 16b in which the wiring pattern 16e is formed instead of forming the ground pattern 18 on that area, and the electronic parts 19 are placed on the metal sheet 30. When the electronic parts 19 are thus placed on the metal sheet 30, through holes need to be formed in the metal sheet 30 at positions corresponding to the through holes 16d. The metal sheet 30 thus attached to the lower surface 16b has the same effect as the ground pattern 18 formed on the lower surface 16b. The meal sheet 30 may be applied to the central area 16c in the upper surface 16a with the insulating film 31 facing the upper surface 16a so as to cover the wiring pattern 16e formed in the central area 16c.

Although the technical idea of the present invention has been described as applied to the printed wiring board provided with the antenna control circuit, the present invention can be practiced by an antenna unit having the foregoing configuration. The antenna unit includes an antenna having plural directivities; and an antenna control circuit for switching directivities of the antenna; the antenna control circuit is formed in a predetermined area on one of both surfaces of the printed wiring board contained in a housing of the antenna unit, the antenna includes four flat antenna elements of a predetermined length connected to the antenna control circuit the four flat antenna elements are formed on a surface of the printed wiring board that is opposite the surface on which the antenna control circuit is formed so as to extend radially outward at equal angular intervals from the predetermined area, and a ground pattern having openings corresponding to through holes used for mounting the antenna control circuit on the printed wiring board is formed to cover the predetermined area.

This printed wiring board provided with the antenna control circuit is similar in operation and effect to the foregoing printed wiring board provided with the antenna control circuit.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. A printed wiring board, comprising:
an antenna control circuit for switching directivities of an antenna having plural directivities;
the antenna control circuit is formed in a predetermined area on the printed wiring board, and
plural flat antenna elements of a predetermined length forming the antenna and connected to the antenna control circuit are arranged so as to extend radially outward around the predetermined area on one of both surfaces of the printed wiring board.

2. The printed wiring board according to claim 1, wherein the plural antenna elements are formed on a surface of the printed wiring board that is opposite the surface on which the antenna control circuit is formed, and a ground pattern is attached to the surface on which the antenna control circuit is formed so as to cover the predetermined area excluding parts of thereof in which through holes for mounting the antenna control circuit are formed.

3. The printed wiring board according to claim 2, wherein the ground pattern is a metal sheet separate from the printed wiring board, having one surface coated with an insulating member and attached to the printed wiring board with the insulating member facing the printed wiring board.

4. An antenna unit comprising:
an antenna having plural directivities; and
an antenna control circuit for switching directivities of the antenna;
the antenna control circuit is formed in a predetermined area on one of both surfaces of the printed wiring board contained in a housing of the antenna unit,
the antenna includes four flat antenna elements of a predetermined length connected to the antenna control circuit
the four flat antenna elements are formed on a surface of the printed wiring board that is opposite the surface on which the antenna control circuit is formed so as to extend radially outward at equal angular intervals from the predetermined area, and
a ground pattern having openings corresponding to through holes used for mounting the antenna control circuit on the printed wiring board is formed to cover the predetermined area.
